(19) United States
(12) Patent Application Publication
(10) Pub. No.: US 2015/0314377 A1
(43) Pub. Date: Nov. 5, 2015

(54) APPARATUS FOR ALIGNING HOLES IN CABINETRY

(71) Applicant: Michael James Wise, Crovallis, OR (US)

(72) Inventor: Michael James Wise, Crovallis, OR (US)

(21) Appl. No.: 14/703,768

(22) Filed: May 4, 2015

Related U.S. Application Data
(60) Provisional application No. 61/988,402, filed on May 5, 2014.

(51) Int. Cl. B23B 49/02

(52) U.S. Cl. CPC B23B 49/02; B23B 2260/088; B23B 2247/12

(57) ABSTRACT

An apparatus comprises a rectangular frame having horizontal sides with horizontal lengths, vertical sides with vertical lengths, a hollow area between the horizontal and vertical sides, a first facing side, and a second facing side. The first facing side comprising an English measurement scale. The second facing side comprising a Metric measurement scale. Two vertical members are slidably disposed between the horizontal sides within the hollow area. Two drill guides are configured to be removably joined to the vertical members at desired locations. A horizontal guide wing is removably joinable to a one of the horizontal sides. A vertical guide wing is removably joinable to a one of the vertical sides.

### CROSS-REFERENCE TO RELATED APPLICATIONS

The present Utility patent application claims priority benefit of the [U.S. provisional application for patent Ser. No. 61/988,402, filed on 2014, May 5 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to a device and system for placing aligned holes within cabinetry. More particularly, the invention relates to a means to easily and accurately attach pull handles and knobs to cabinet doors and drawers such that the holes for the handle hardware are properly aligned.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

By way of educational background, another aspect of the prior art generally useful to be aware of is that, the art presupposes an adjustable drill hole jig. The structure and function of the adjustable drill hole jig is composed of three major components: a base, a primary armature that may be selectively slide able with respect to the base along a first axis A₁ and a secondary armature that may be selectively slide able with respect to the primary armature along a second axis A₂ which is perpendicular to the first axis, wherein each component is preferably formed of plastic via an injection molding process. It will be noted that the guide edge, the upper and lower first guide abutments, and the second guide abutment are symmetrical about the plane P so that the guide hole jig is fully reversible in operation with respect to the corners of a work piece. The ancillary primary armature component is planar, having a complementary portion of the second guide opening formed therein. Align ability with respect to the holes, is a second constituent of the threaded fasteners in the form of screw posts. Each of the screw posts have a head fixedly anchored in the ancillary primary armature component and a cylindrical shank having inside threads for thread ably engaging the screws. The secondary armature is provided with a series of guide holes, wherein when the primary and secondary armatures are mounted onto the base, the guide holes are oriented normal to the plane P. Preferably, each guide hole includes a hardened metallic bushing press-fit into respective apertures formed in the secondary armature. Preferably, the guide holes are linearly aligned and arranged so as to provide several relative hole spacings to thereby accommodate a spectrum of sizes of handles. It is preferred for the hole guides to include a main guide hole and a plurality of satellite guide holes arranged linearly with respect to the main guide hole, and further, arranged in a group spaced distally from the main guide hole. For example, the main guide hole may be spaced from the satellite guide holes, wherein a nearest satellite guide hole is spaced 3 inches on center from the main guide hole, the next satellite guide hole is spaced 3.5 inches on center from the main guide hole, and the farthest satellite guide hole is spaced 4 inches on center from the main guide hole.

By way of educational background, another aspect of the prior art generally useful to be aware of is that, the art presupposes a cabinet door knob pull measuring jig comprising a frame having a baseboard and a backboard, a drilling plate adjustably attached to a vertical slot located in the backboard and at least one sliding block located in a vertical slot on the drilling plate for the acceptance of a drill bit. By way of educational background, to use, a person first places a cabinet door flush along the baseboard and backboard. Then, he or she adjusts the drilling plate in the vertical slot on the backboard and the sliding block in the vertical slot on the drilling plate so as to pinpoint the exact location in which a hole for a knob pull is to be drilled. Next, he or she secures the drilling plate and sliding block so they do not move. Finally, a person inserts a drill bit into a pilot hole and drills a hole into the cabinet door. Markings on the baseboard and backboard permit the user to determine the measurements from the edge of the cabinet door that were used. The user simply positions another cabinet door in the measuring jig to continue drilling accurate and precise holes into cabinet doors. In addition, a person may flip the jig and use the reverse side of the measuring jig to measure and drill holes into the opposite side, for instance, left hand side, of the cabinet door.

Further, other aspects of the prior art specify an “L” shaped guide edge which is permanently attached at the vertical and horizontal edges. It is believed that, not allowing the guide wings to be removed, or working on cabinet doors with curved art on the same corner edge, may result in the jig not being square. One can expect that the failure in making a perfect fit in accurately installing a pull knob or handle on left and right cabinetry may result in uneven placements of knobs and handles.

These systems may not effectively provide a system and/or method that may be capable of aligning squarely, and evenly, cabinet and drawer hardware. A solution which did so would be desirable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary DIY Pull Handle Guide, in accordance with an embodiment of the present invention;

FIG. 2 illustrates a detailed perspective assembly view of an exemplary DIY Pull Handle Guide, in accordance with an embodiment of the present invention;

FIG. 3 illustrates a detailed perspective application view of an exemplary DIY Pull Handle Guide, in accordance with an embodiment of the present invention;

FIG. 4 illustrates a detailed perspective assembly view of an exemplary DIY Pull Handle Guide, in accordance with an embodiment of the present invention;

FIG. 5 illustrates exploded top and side perspective views of an exemplary installation using the DIY Pull Handle Guide, in accordance with an embodiment of the present invention;

FIG. 6 illustrates an exploded top and side perspective application view of an exemplary DIY Pull Handle Guide, in accordance with an embodiment of the present invention;

FIG. 7 illustrates a detailed perspective application view of an exemplary DIY Pull Handle Guide, in accordance with an embodiment of the present invention; and

FIG. 8 illustrates a detailed perspective application view of an exemplary DIY Pull Handle Guide, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit “about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation of any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Many embodiments of the present invention may provide means and methods for a system used for guiding drill holes in left and right cabinet doors and drawers for installation of pull handles and knobs, mitigating inaccuracies in measuring and drilling holes into cabinetry. The apparatus for many embodiments may allow the operator the choice to flip the device over and use the template to drill holes with the same measurements at the same measured locations on right hand or left hand cabinet doors without the need for re-measurement. In many embodiments the device template may be used for drawers which may also have left and right orientations as well as centered orientation.

DIY Pull Handle Guide may facilitate the end user to easily and precisely install pull knobs with a single screw attachment or pull handles with two screw attachments. In some embodiments the screws on the pull handles may be less than one inch apart and/or as far as eleven plus inches apart. In alternative embodiments, the screws on the pull handles may be any distance apart. The DIY Pull Handle Guide comprises two hardened steel drill guides that may be moved to any placement inside the hollow rectangular frame housing. The hardened steel drill guides may be as close as touching one another, and may also be moved horizontally, vertically, or diagonally at opposite ends of the DIY Pull Handle Guide and may be placed in any suitable configuration within the rectangular frame housing. The hardened steel drill guides may be attached to one vertical member at the same time or each hardened steel drill guide may be attached to separate sliding vertical members at the same time. The use and configuration of guide wings on two opposing surfaces of the device may allow the user to work on and install hardware on cabinet doors and drawers that may not be exactly square, as well as cabinet doors and drawers with curved art or rounded corners. In some embodiments, the guide wings may be removable to allow the apparatus to be used for other purposes, for example, without limitation, to drill holes to attach electrical conduit or plumbing pipe, or to hang pictures.

DIY Pull Handle Guide may be used with English and Metric measuring standards to facilitate the end user if or when using two different measuring systems to install the pull handles and/or pull knobs accurately and precisely. The rectangular frame and each of the two vertical members has English measurements on one side of the device and Metric measurements on the other side of the device.

In some embodiments, DIY Pull Handle Guide may comprise a hollow rectangular frame with two vertical members with numbered measurements slide ably disposed between the elongated sides of the frame, and a hardened steel drill guide slide ably disposed on each of the vertical members. It is contemplated the device may provide accurate measurements, and be a desirable instrument in attaching pull handles and pull knobs to cabinet doors and drawers with holes for the handles/knobs being properly aligned. The rectangular frame may further comprise measurement indicia disposed along the horizontal perimeter of the frame so that the hardened steel drill guide and members may be properly aligned. In some embodiments, the two guide wings located on the DIY Pull Handle Guide may not touch at any point either vertical or horizontal, thus allowing the device to work on cabinet doors that may not be perfectly square, as well as work on cabinet doors with rounded corners or wood carvings on the corners.

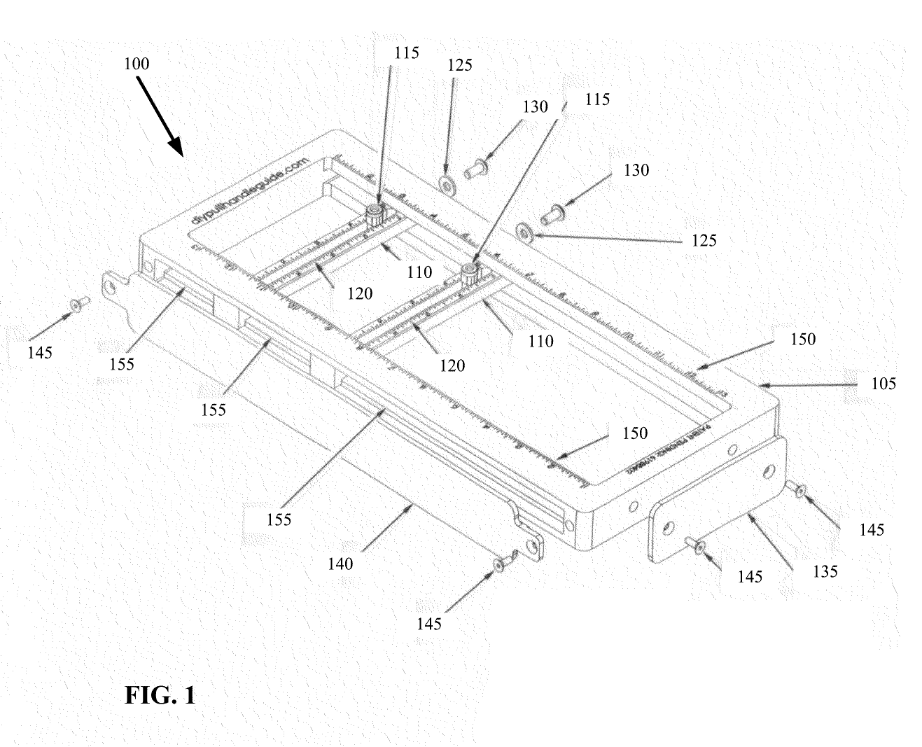

FIG. 1 illustrates a detailed perspective view of an exemplary DIY Pull Handle Guide, in accordance with an embodiment of the present invention.

In one embodiment, the DIY handle guide 100 comprises a hollow rectangular frame 105 and two vertical members 110 slide ably disposed between the elongated sides of the hollow rectangular frame 105, and two 3/16 inch hardened steel drill guides 115 which are also slide ably disposed on each of the vertical members. The two vertical members 110 further comprise measurements 120 indicia in English. There is a washer 125 and screw 130 on one side of the frame that locks each of the vertical members 110 exactly where the end user wants the vertical members to be. The hollow rectangular frame 105 has two removable guide wings 135 and 140, respectively, whereby the short guide wing 135 runs vertically with reference to the frame housing, and the long guide wing 140 runs horizontally with reference to the frame housing. Screws 145 are used to secure the guide wings to the DIY handle guide. Located within the hollow rectangular frame 105 is a track 155 that allows the two vertical members to slide horizontally within the frame housing. The guide wings do not connect to or touch the other. The hollow rectangular frame 105 further comprises measurement 150 indicia in English disposed along the elongated perimeter of the frame so that the hardened steel drill guides and vertical members can be properly aligned.

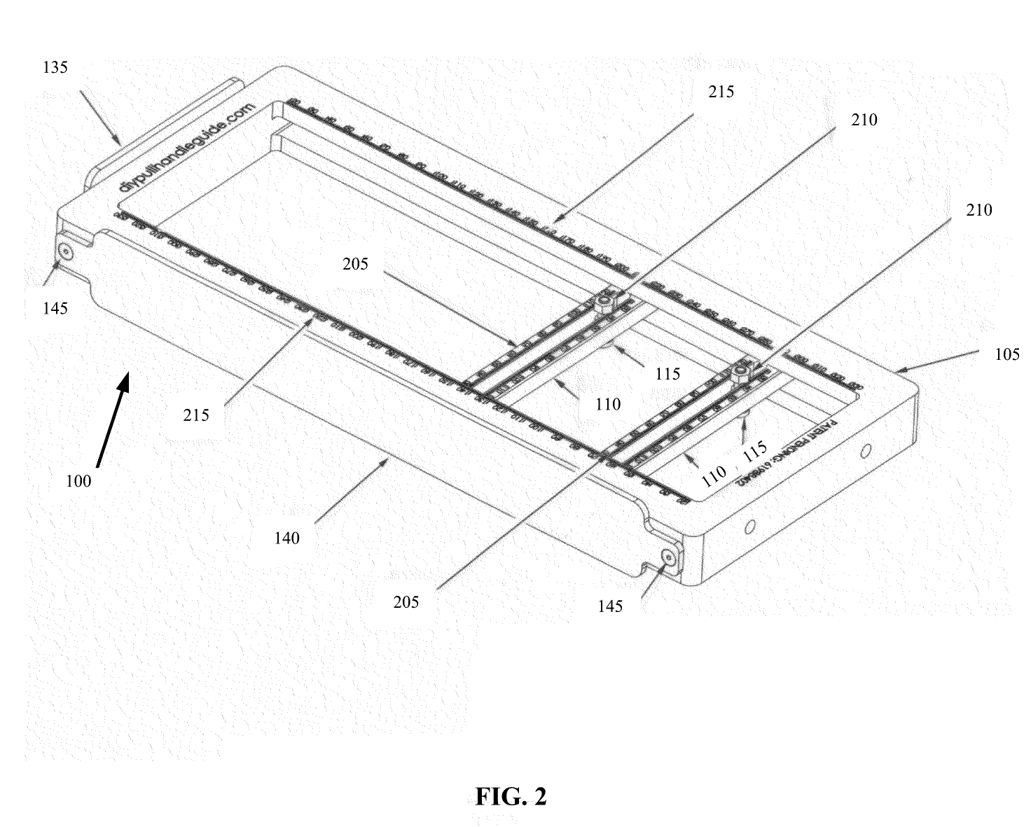

FIG. 2 illustrates a detailed perspective assembly view of an exemplary DIY Pull Handle Guide, in accordance with an embodiment of the present invention. In one embodiment, the two vertical members 110 further comprise measurements 205 indicia in Metric which may be located on the on the opposite, or reverse side of the device. In some embodiments, it is contemplated that a slide rule-like device may be placed over the housing incorporating both English and Metric measurements on each individual face of the DIY Pull Handle Guide assembly. The hollow rectangular frame 105 further comprises measurements 215 indicia in Metric disposed along the elongated perimeter of the frame so that the hardened steel drill guides 115 and vertical members 110 can be properly aligned. There are nuts 210 that loosen and tighten on one side of each of the two hardened steel drill guides 115 to lock the hardened steel drill guides exactly where the end user wants the hardened steel drill guide to be on the vertical members 110.

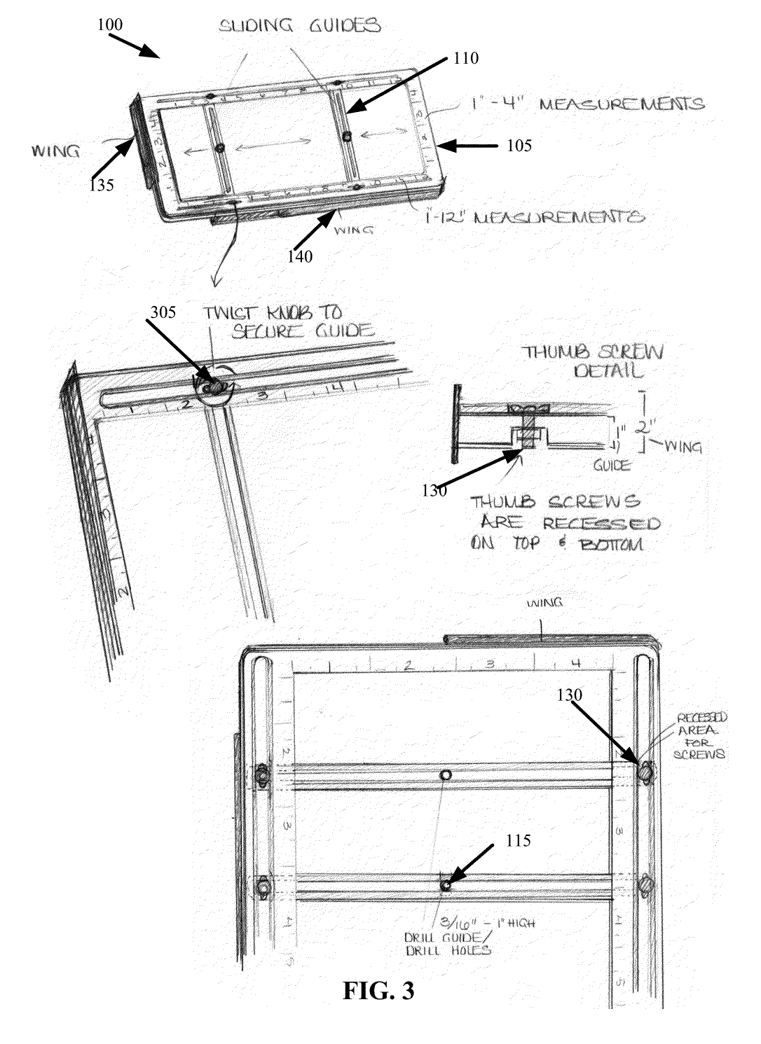

FIG. 3 illustrates a detailed perspective application view of an exemplary DIY Pull Handle Guide, in accordance with an embodiment of the present invention. In some embodiments screws 130 may be recessed, or countersunk into the rectangular frame 105 housing on both the front surface and also the opposite facing surface. In some embodiments, a twist knob 305 may be used to secure the screws in a locking or unlocking fashion, which may allow for greater ease of adjustability and measuring. In some alternate embodiments, other means may be employed for securing vertical members 110 such as, but not limited to, locking levers.

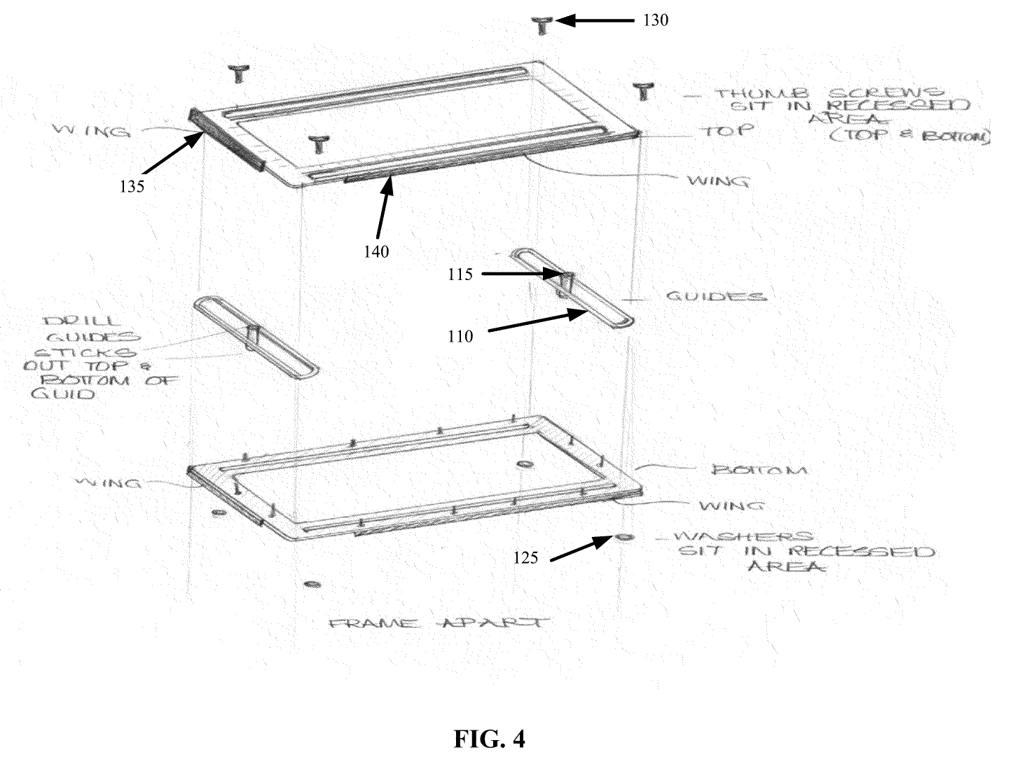

FIG. 4 illustrates a detailed perspective assembly view of an exemplary DIY Pull Handle Guide, in accordance with an embodiment of the present invention. In some embodiments, drill guides 115 protrude from the top and bottom of the vertical members 110 for ease of placement of the drill being used to drill holes.

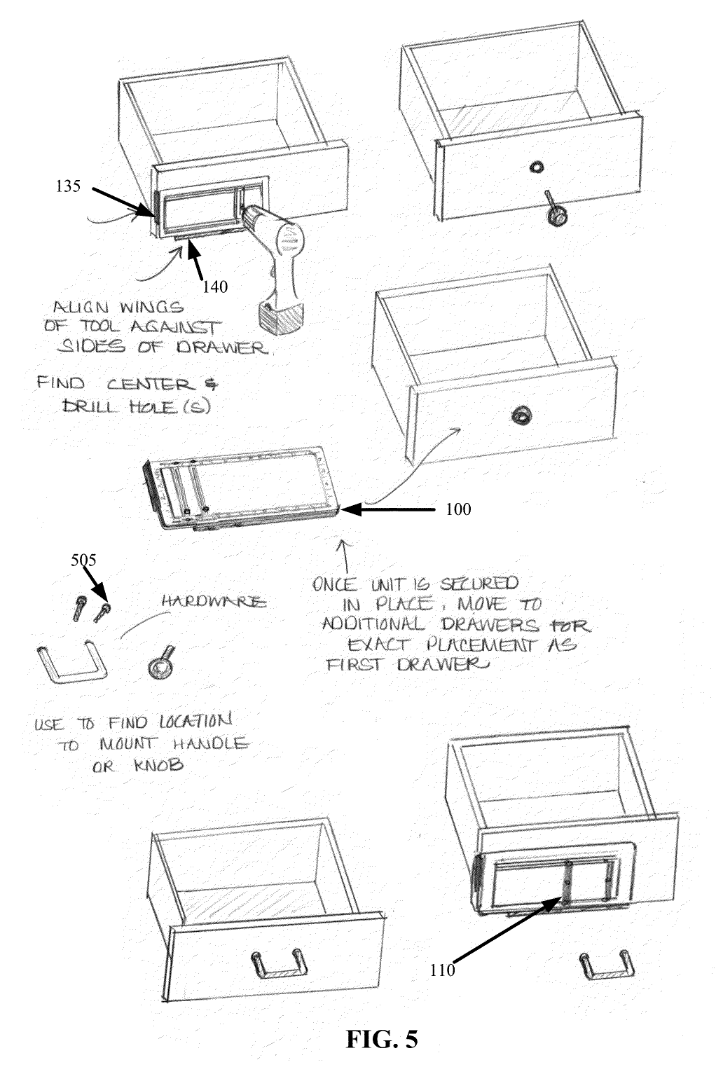

FIG. 5 illustrates exploded top and side perspective views of an exemplary installation using the DIY Pull Handle Guide, in accordance with an embodiment of the present invention. In some embodiments, DIY Pull Handle Guide 100 may be used for drilling holes in drawers; whereby the alignment of wings 135 and 140 against the outer edge of the drawer surface may be performed first. Once the wings 135 and 140 are adjusted and locked into place, proper measurements of the vertical members 110 may be performed, thus allowing for perfect placement of holes in all drawers being drilled into. In some embodiments, hardware 505 may be included in the device for commercial sale. It is contemplated that different types of hardware may be used, and not solely limited to hardened steel. It is also contemplated that most hardware from any plurality of home improvement or supply companies may be used with the DIY Pull Handle Guide.

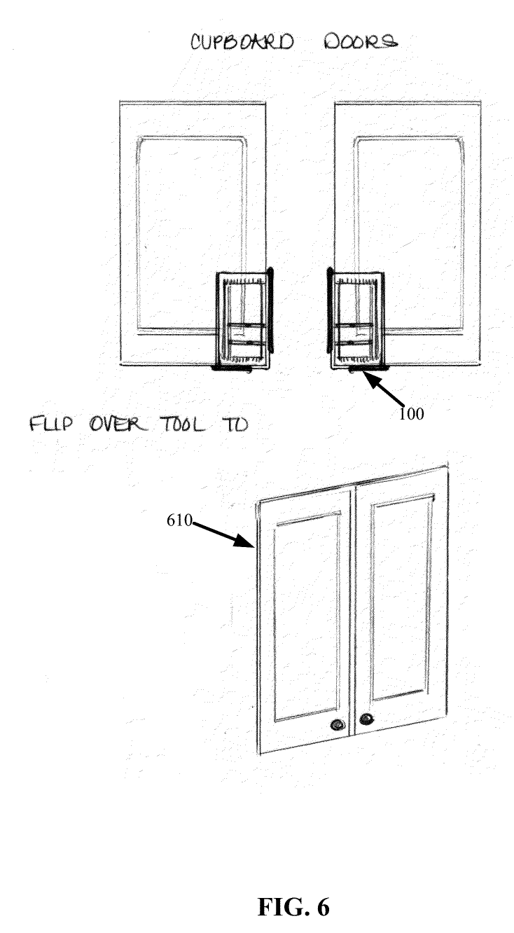

FIG. 6 illustrates an exploded top and side perspective application view of an exemplary DIY Pull Handle Guide, in accordance with an embodiment of the present invention. In some embodiments, DIY Pull Handle Guide 100 may be flipped about its vertical axis and used to measure and create the same identical drill marks on left and right cabinetry, respectively. Once the holes are drilled, and the appropriate hardware installed, equal alignment of holes and of hardware may be noticeable on cabinetry 610.

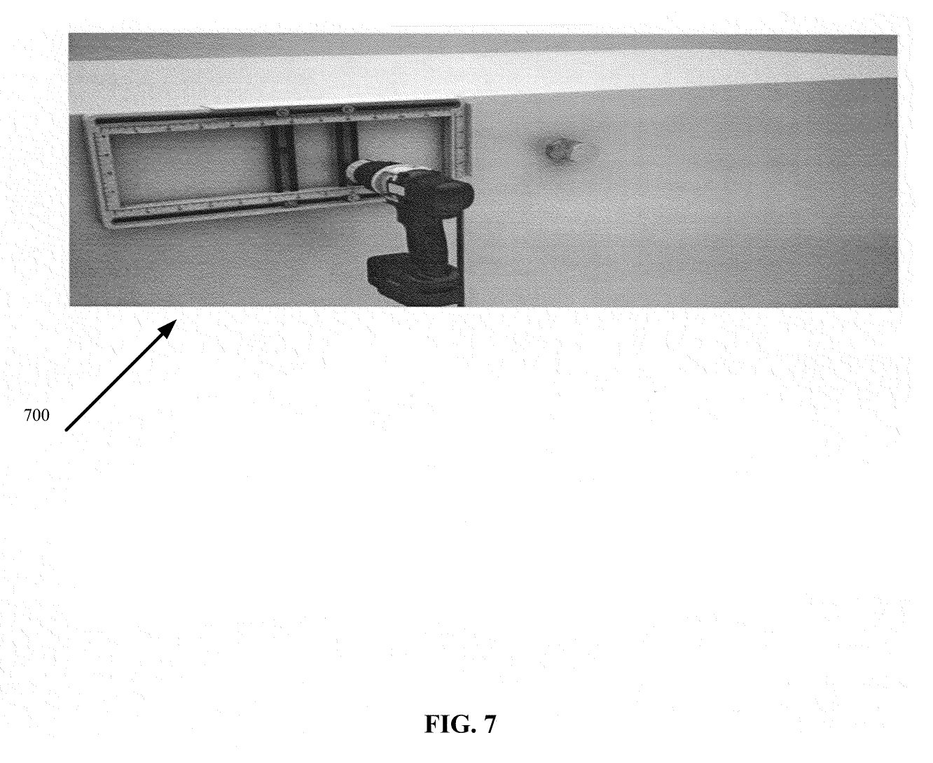

FIG. 7 illustrates a detailed perspective application view of an exemplary DIY Pull Handle Guide, in accordance with an embodiment of the present invention. Drill placement procedure 700 illustrates how a user may align wings 135 and 140 as well as vertical members 110, in order to precisely drill in the correct or desirable locations on a cabinet door set obtaining left and right placements.

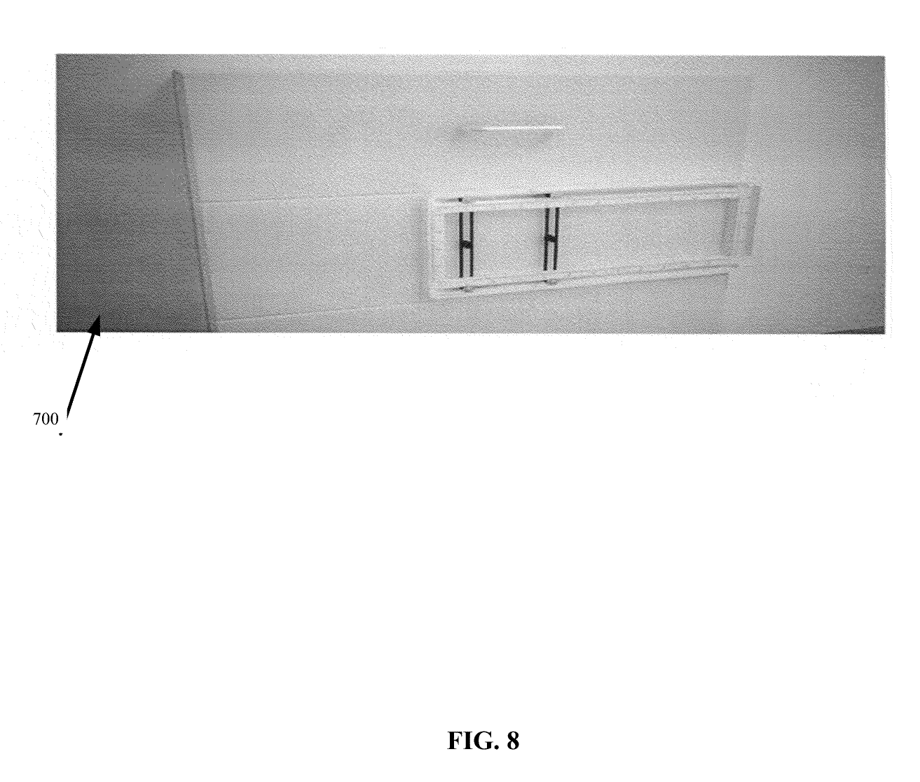

FIG. 8 illustrates a detailed perspective application view of an exemplary DIY Pull Handle Guide, in accordance with an embodiment of the present invention. Drill placement procedure 700 illustrates how a user may align wings 135 and 140 as well as vertical members 110, in order to precisely drill in the correct or desirable locations on a dresser drawer set obtaining centered placements. When drilling two holes for a handle, a user may place the DIY Pull Handle Guide over the cabinet, or drawer door, where the handle is to be placed. The user then may move the first vertical member 110 and the hardened steel drill guide 115 to the exact spot desired for one of the holes to be drilled. The user may then tighten the first vertical member 110 and tighten the first hardened steel drill guide 115. The DIY Pull Handle Guide may then be removed from the cabinet door, or drawer. The user may then insert the handle screw through the backside of the hardened steel drill guide 115 and attach the handle to the screw. Once complete, the user may move the second vertical member 110 and the second hardened steel drill guide 115 to align the hole to the second hole of the door handle. Once aligned, the user may then insert the second handle screw through the backside of the second hardened steel drill guide. The user may then tighten the second vertical member 110 and tighten the second hardened steel drill guide 115, and then remove the handle from the DIY Pull Handle Guide and move to an opposing door or separate drawer maintaining the exact same position and measurements that were taken initially. The user may now drill the holes.

In alternative embodiments of the DIY Pull Handle Guide, it is contemplated that many other suitable materials may be used for the housing structure and incorporated system components. For example, without limitation, rather than using hardened steel materials, other suitable materials may include: Aluminum, carbon fiber, titanium, diamond, and any combinations of plastics, rubbers or composite materials. It is also contemplated that the device may be any size of rectangular dimensions such that special, or out of the ordinary, dimensions may be completed with ease and accuracy avoiding costly mistakes. For example, without limitation, a corporation X may have purchased a large piece of machinery, which was delivered from manufacturer Y, without certain holes drilled in specified locations for purposes of handles, knobs, electronics, additional mechanized features, or safety features. Corporation X, due to production standards, may not be willing to send the machinery back to manufacturer Y due to the incurred losses. Corporation X may then choose to have the machinery fixed in house while production is still ongoing. In this instance, it is contemplated that Corporation X may use the DIY Pull Handle Guide to specifically accomplish the obstacles faced at a reasonable and justifiable cost.

In another alternative embodiment, it is not uncommon to have to place drilled holes within glass surfaces; it is contemplated that DIY Pull Handle Guide may also incorporate a suction type of device located around the rectangular housing as well as within the vertical members and drill guides for purposes of pressurizing the glass in locations other than where the drill hole would be placed to prevent cracking, shattering, or spider webbing of the glass. For example, without limitation, this may be used in commercial or governmental office buildings or residences where it is desired to drill holes in glass doors, or glass cabinetry, or glass walls for installation of hand railings. It is also contemplated that any suitable plurality of vertical members may be incorporated into the DIY Pull Handle Guide.

In yet another alternative embodiment, it is contemplated that DIY Pull Handle Guide may incorporate an attachable/detachable arm or clip-like device onto the device to allow disabled persons to utilize the product with much greater ease of use. It is contemplated that the arm or clip-like device would allow the product to stay in place without the need to hold the product on the door, drawer, or any other suitable use, which may allow for the use two hands for the drill or other necessities. It is further contemplated that an application performing this function may also be useful in industry applications.

In yet another alternative embodiment, it is contemplated that two to three leveling bubbles may be incorporated into the DIY Pull Handle Guide. The placement of the bubbles may be horizontal, vertical, or any variation in between. It is contemplated that a feature such as this would aide in properly aligning holes, as well as properly aligning whichever product or application you are mounting, for example, without limitation, hanging pictures on a wall.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a device and system for placing aligned holes within cabinetry according to the present invention will be apparent to those skilled in the art. Various aspects of the invention have been described above by way of illustration, and the specific embodiments disclosed are not intended to limit the invention to the particular forms disclosed. The particular implementation of the device and system for placing aligned holes within cabinetry may vary depending upon the particular context or application. By way of example, and not limitation, the device and system for placing aligned holes within cabinetry described in the foregoing were principally directed to a means for easily and accurately attaching pull handles and knobs to cabinet doors and drawers such that the holes for the handle hardware are properly aligned implementations; however, similar techniques may instead be applied to alignments of holes within manufacturing or medical environments whereby precision is critical, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a substantially rectangular frame having horizontal sides with horizontal lengths, vertical sides with vertical lengths, a hollow area between said horizontal and vertical sides, a first facing side, and a second facing side, said horizontal lengths being greater than said vertical lengths, said first facing side comprising an English measurement scale, said second facing side comprising a Metric measurement scale;
at least two vertical members being slidably disposed between said horizontal sides within said hollow area, said vertical members having a first facing vertical member side and a second facing vertical member side;
at least two drill guides being configured to be removably joined to said vertical members at desired locations;
a horizontal guide wing being removably joinable to a one of said horizontal sides, a joined horizontal guide wing extending beyond said first facing side and said second facing side; and
a vertical guide wing being removably joinable to a one of said vertical sides, a joined vertical guide wing extending beyond said first facing side and said second facing side.

2. The apparatus as recited in claim 1, further comprising means for securing said vertical members at desired locations in said hollow area.

3. The apparatus as recited in claim 1, further comprising means for securing said drill guides at said desired locations on said vertical members.

4. The apparatus as recited in claim 1, in which said first facing vertical member side comprises an English measurement scale and a second facing vertical member side comprises a Metric measurement scale.

5. The apparatus as recited in claim 1, in which said horizontal sides further comprise tracks for slidably engaging said vertical members.

6. The apparatus as recited in claim 1, in which a joined drill guide extends beyond said first facing vertical member side and said second facing vertical member side.

7. The apparatus as recited in claim 1, in which said vertical members further comprise vertical slots for positioning said drill guides.

8. The apparatus as recited in claim 1, in which said joined horizontal guide wing is not in engagement with said joined vertical guide wing.

9. The apparatus as recited in claim 1, in which said drill guides further comprise hardened steel.

10. The apparatus as recited in claim 1, in which said horizontal length and said vertical length comprise dimensions for engaging a cabinet door and a cabinet drawer.

11. The apparatus as recited in claim 10, further comprising hardware for cabinets.

12. An apparatus comprising:
means for enclosing a hollow area with measurement scales;
means for slidably positioning in said hollow area;
means for guiding a drill at a location on said positioning means;
means for horizontally guiding said enclosing means; and
means for vertically guiding said enclosing means.

13. The apparatus as recited in claim 12, further comprising means for securing said positioning means at desired locations in said hollow area.

14. The apparatus as recited in claim 12, further comprising means for securing said guiding means at locations on said positioning means.

15. An apparatus comprising:
a substantially rectangular frame having horizontal sides with horizontal lengths, vertical sides with vertical lengths, a hollow area between said horizontal and vertical sides, a first facing side, and a second facing side, said horizontal lengths being greater than said vertical lengths, said first facing side comprising an English measurement scale, said second facing side comprising a Metric measurement scale, said horizontal sides further comprising tracks;
at least two vertical members being slidably disposed on said tracks between said horizontal sides within said hollow area, said vertical members having a first facing vertical member side and a second facing vertical member side, said first facing vertical member side comprises an English measurement scale and a second facing vertical member side comprises a Metric measurement scale, said vertical members further comprising vertical slots;
at least two drill guides being configured to be removably joined to said vertical members at desired locations in said vertical slots, wherein a joined drill guide extends beyond said first facing vertical member side and said second facing vertical member side;
a horizontal guide wing being removably joinable to a one of said horizontal sides, a joined horizontal guide wing extending beyond said first facing side and said second facing side; and
a vertical guide wing being removably joinable to a one of said vertical sides, a joined vertical guide wing extending beyond said first facing side and said second facing side, wherein said joined horizontal guide wing is not in engagement with said joined vertical guide wing.

16. The apparatus as recited in claim 15, further comprising means for securing said vertical members at desired locations in said hollow area.

17. The apparatus as recited in claim 15, further comprising means for securing said drill guides at said desired locations on said vertical members.

18. The apparatus as recited in claim 15, in which said drill guides further comprise hardened steel.

19. The apparatus as recited in claim 15, in which said horizontal length and said vertical length comprise dimensions for engaging a cabinet door and a cabinet drawer.

20. The apparatus as recited in claim 19, further comprising hardware for cabinets.
